(19) United States
(12) Patent Application Publication
(10) Pub. No.: US 2015/0230439 A1
(43) Pub. Date: Aug. 20, 2015

(54) Aquaponics Systems, Apparatus, and Methods

(71) Applicant: Adam Harwood, San Marcos, TX (US)

(72) Inventor: Adam Harwood, San Marcos, TX (US)

(21) Appl. No.: 14/628,110

(22) Filed: Feb. 20, 2015

Related U.S. Application Data
(60) Provisional application No. 61/942,114, filed on Feb. 20, 2014.

(51) Int. Cl. A01K 63/04

(52) U.S. Cl. CPC A01K 63/045; A01K 63/042; A01K 63/047

(57) ABSTRACT

Aquaponics machines, systems, methods, components, apparatus etc. Some such systems comprise solids/water separators, fish rearing tanks, and surface drains. The surface drains are in fluid communication with the separators and are positioned in the fish rearing tanks so as to drain solids/water mixtures from the surfaces of the water therein. Moreover, they are positioned to drain the solids/water mixtures to the separators whereby the separators separate fecal matter from the water. In some embodiments, thin film strippers are in the separators. Pumps in some systems can be further configured to pump water at a rate sufficient to create a vortex at the thin film strippers. If desired, the surface drains can be positioned near a downwind side of the fish rearing tanks. Furthermore, air stones spaced apart from the surface drains can over-aerate the water. Some systems further comprise plant growing tanks and/or polyethylene grow rafts positioned therein.

### CROSS REFERENCE TO RELATED APPLICATIONS

This application claims priority to and is a non-provisional application of U.S. provisional patent application No. 61/942,114 titled Aquaponics Related Apparatus, Compositions of Matter, and Methods, filed by Adam Harwood on Feb. 20, 2014 the entirety of which is incorporated herein as if set forth in full.

### BACKGROUND

Famine and drought exist in many places even in these modern times. For instance, sub-Sarahan Africa has been experiencing increasingly frequent periods of both types of disasters. Yet, it does not take an outright famine or drought to make food and/or water scarce (or at least scarce enough that prices for them increase). More specifically, at the time of this writing, both California and Texas in the United States have undergone separate multi-year droughts leading to crop failures and restrictions on water use.

Other factors, of course, contribute to the price of food. The fertilizers required to grow food with heretofore available methods and with heretofore available technology also contributes to the availability and price of food. These consumables must be periodically used and then replenished with attendant material and labor costs that are typically passed on to the consumer. The land on which food (plants and/or animals) is grown also represents a significant cost driver in that the land represents potentially valuable real estate. And, in many areas, arable land is under increasing population pressure for housing, commercial, industrial, etc. uses. And, in certain countries, environmental regulations further restrict the amount of land available for agriculture and restrict the techniques acceptable for use in agriculture thereon.

Additionally, consumers have become increasingly concerned about the substances that might be in the food they consume. Indeed, a burgeoning “organic” food industry has sought to supply enough uncontaminated food to a consumer base that seeks ever purer food. And, because of the factors discussed above as well as perhaps others, demand continues to outstrip supply.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for growing food in aquaponics systems and more specifically for growing high purity fish and edible crops in aquaponics systems while also producing high quality fertilizer.

Moreover, it has been found that aquaponics systems and/or machines of embodiments disclosed herein grow food with no detectable impurities. Furthermore, such systems and/or machines produce recirculating water with properties far superior to that required by SRAC (Southern Regional Aquaculture Center) paper 454. It is noted herein that at least one government Analysts who tested these water, produce, and fish samples expressed surprise that such results were possible (much less expected).

Some embodiments provide agricultural machines for rearing fish and which comprise solids/water separators, fish rearing tanks, and surface drains. The solids/water separators are configured to separate solids and water from each other while the fish rearing tanks are configured to contain fish in water recirculated therein. As to the surface drains of the current embodiment, they are in fluid communication with the solids/water separators and are positioned in the fish rearing tanks so as to drain solids/water mixtures from the surfaces of the water in the fish rearing tanks. Moreover, they are positioned so as to drain the solids/water mixtures to the solids/water separators whereby the solids/water separators separate fish fecal matter from the water.

In some embodiments, the fish rearing tanks and the solids/water separators are further configured to gravity drain the solids/water mixture to the solids/water separators. Further, in agricultural machines of various embodiments thin film strippers are positioned in the solids/water separators. Some agricultural machines further comprise pumps in communication with the fish rearing ranks and which are positioned upstream of the fish rearing tanks. These pumps can be further configured to pump water at a rate sufficient to create vortices at the entrances to the thin film strippers. If desired, the surface drains can be positioned near a side of the fish rearing tanks downwind from the prevailing winds in the vicinity of the fish rearing tanks. Agricultural machines of some embodiments further comprise air stones spaced apart from the surface drains and air pumps in fluid communication with the air stones and which are configured to pump air at rates sufficient to over-aerate the water in the fish rearing tanks. In the alternative, or in addition, some agricultural machines of the current embodiment further comprise plant growing tanks in fluid communication with the solids/water separators and polyethylene grow rafts positioned in the plant growing tanks.

In accordance with embodiments various aquaponics-related methods are supplied. For instance, in the current embodiment an agriculture method for raising fish is provided. This method comprises draining a solids/water mixture from the surface of the water in a fish rearing tank and to a solids/water separator. The solids/water separator is configured to separate solids and water in the solids/water mixture via a surface drain positioned in the fish rearing tank so. The current method also comprises separating at least some of the solids from the water of the solids/water mixture using the solids/water separator whereby fish fecal matter is separated from the water.

In some methods, the fish rearing tank and the solids/water separator are further configured to gravity drain the solids/water mixture to the solids/water separator. If desired, the current method can further comprise passing the water separated from the solids through a thin film stripper positioned in the solids/water separator.

Furthermore, some methods further comprise pumping the water into the fish rearing rank with a pump positioned upstream of the fish rearing tank. Note that the pump can be configured to pump the water at a rate sufficient to create a vortex at the entrance to the thin film stripper. Also, if desired, the surface drain is positioned near a side of the fish rearing tank downwind from a prevailing wind in a vicinity of the fish rearing tank. The current method, moreover, can further comprise spacing apart a plurality of air stones from the surface drain. In addition, or in the alternative, the current method can further comprise pumping air at a rate sufficient to over-aerate the water in the fish rearing tank with an air pump in fluid communication with the air stones. In accordance with some embodiments the methods can further comprise growing plants in a plant growing tank in fluid communication with the solids/water separator. Note that various aquaponics components, apparatus, systems, machines, etc. disclosed herein are available from Apex Aquaponics, LLC, of San Marcos, Tex.

Furthermore, some embodiments provide up-cycled systems in which conventional systems are modified to comprise at least some portion of aquaponics systems and/or techniques disclosed herein. For instance, existing fish ponds can be drained, lined with plastic, and can have air stones, surface drains, thin film strippers, etc. added to their configuration to convert them to systems with many features described herein. Thus, existing fish ponds can be improved in accordance with embodiments.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and/or nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1A illustrates an aquaponics systems.

FIG. 1B illustrates another aquaponics system.

FIG. 2 schematically illustrates an aquaponics system.

FIG. 3 illustrates a surface drain of a fish rearing tank of an aquaponics system.

FIG. 4 illustrates a thin film stripper of a solids/water separator of an aquaponics system.

FIG. 5 illustrates a grow raft of an aquaponics system.

FIG. 6 illustrates a flowchart of a method of growing food in an aquaponics system.

### DETAILED DESCRIPTION

This document discloses systems, apparatus, methods, etc. for growing food in aquaponics systems and more specifically for growing high purity fish and edible crops in aquaponics systems while also producing high quality fertilizer.

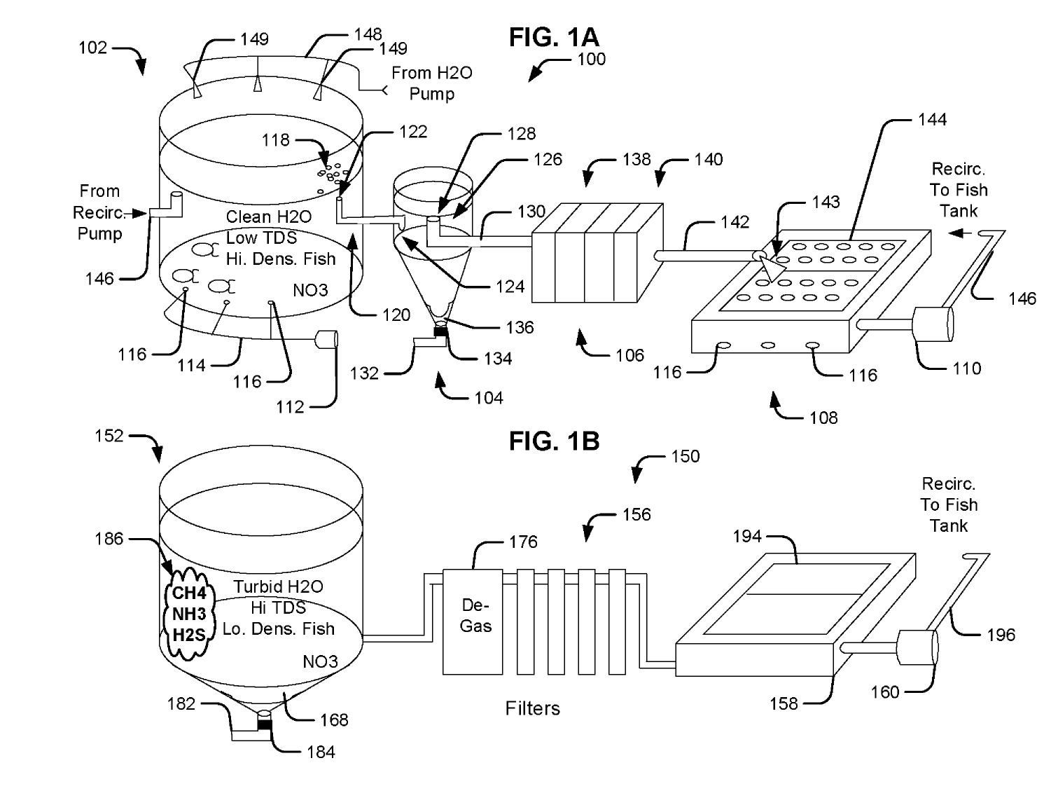

FIG. 1A illustrates an aquaponics systems. The Aquaponics system 100 of the current embodiment grows fish and vegetation with undetectable levels of impurities. Moreover, these foodstuffs grow much larger and in greater density than possible in heretofore available systems and they do so with relatively little in the way of consumables or operator (human) intervention. They have has shown a resiliency over and above heretofore available systems particularly if outside materials are excluded from them. Accordingly, at least some of those skilled in the art have deemed these systems “agricultural machines” in acknowledgement of their superior abilities to reliably produce impurity free fish and produce in large quantities.

Furthermore, system 100 of the current embodiment maintains its water in a far cleaner condition than heretofore available systems. The water in system 100 possesses low turbidity, low TDS (total dissolved solids), and little in the way of organic decomposition products such as methane, ammonia, hydrogen sulfide, nitrite, etc. Thus, the fish and plants grown in the system 100 of the current embodiment are typically “safe,” healthy, and grow to their full potential.

FIG. 1B illustrates another aquaponics system. In contrast to the system 100 of FIG. 1A, the system 150 of FIG. 1B grows fish and vegetation with detectable levels of impurities and indeed often undesirable impurity levels. Moreover, these organisms are often stunted and can only survive in lower population densities than possible in system 100. Despite, the low density and potentially stunted state of the organisms therein, system 150 often requires the addition of consumables and/or operator (human) intervention if it is to be maintained in a “balanced” state (if that is even possible).

Furthermore, system 150 often holds its water in a less than clean condition. The water in system 100 often possesses high turbidity, high TDS, and noticeable (if not unhealthy) levels of organic decomposition products such as methane, ammonia, hydrogen sulfide, nitrite, etc. Thus, the fish and plants grown in the system 150 of the current embodiment often cannot be considered to be “safe,” or healthy and often remain stunted rather than growing to their full potential.

With reference again to FIG. 1A, the system 100 of the current embodiment comprises a fish rearing tank 102, a solids/water separator 104, a filter bank 106, a grow tank 108, a pump 110, an air pump 112, an air manifold 114, air stones 116, surface solids 118, a surface drain 120, an entrance 122, a discharge 124, a thin film stripper 126, an entrance 128, a drain line 130, a solids drain 132, a solids valve 134, solids 136, a green filter media mat 138, a black filter media mat 140, a filter drain line 142, a waterfall 143, grow rafts 144, a recirculation line 146, a water manifold 148, and water nozzles 149. In contrast, the system 150 of FIG. 1B includes a fish rearing tank 152, filters 156, a grow tank 158, a pump 160, solids 168, a degasser 176, a solids drain 182, a solids valve 184, decomposition gases 186, grow rafts 194, and a recirculation line 196.

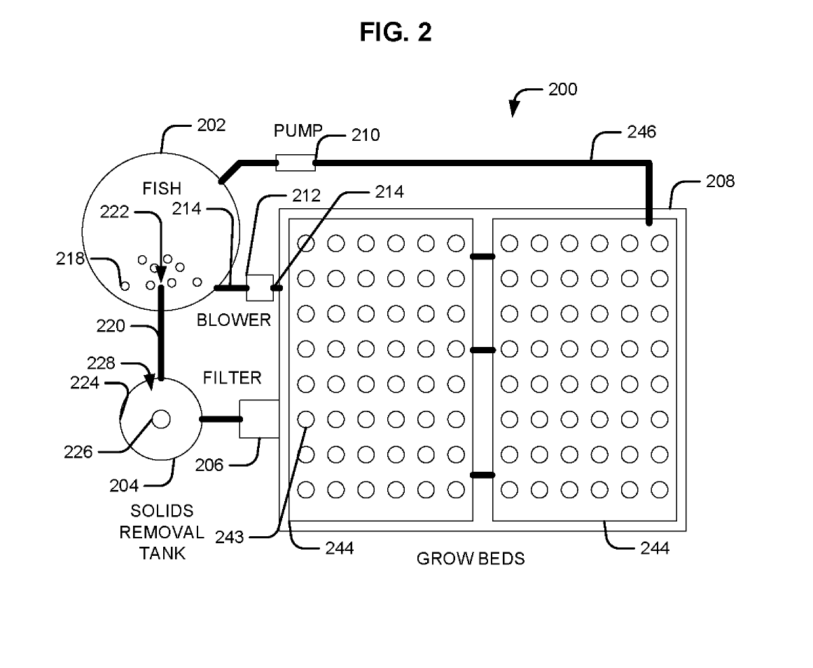

FIG. 2 schematically illustrates an aquaponics system. The system 200 of the current embodiment comprises a fish rearing tank 202, a solids/water separator 204, a filter bank 206, a grow tank 208, a pump 210, an air pump 212, surface solids 218, a surface drain 220, an entrance 122, a discharge 124, a thin film stripper 126, an entrance 128, a waterfall 143, grow rafts 144, and a recirculation line 146. While the aforementioned components are similar to those depicted in FIG. 1A (with corresponding reference numbers) some components have been omitted from FIG. 2 so as not to obscure various embodiments.

Generally speaking, the pump 210 drives the flow of water in the system 200 from the pump through the fish rearing tank 202, to the solids/water separator 204, through the filter bank 206, through the grow tanks 208 (two illustrated in FIG. 2), and thence back to the pump 210 via the recirculation line 246. The fish rearing tank 202 provides a clean, safe, habitable, aquatic environment for the fish that might come to be stocked in the system 200. These fish, of course, require oxygen and food as well as reasonable environmental conditions to live, grow, reproduce, etc. The oxygen is supplied by the air stones 116 in conjunction with the air manifold 114 and the air pump 112. Indeed, as is further disclosed herein, these components (and others) typically over-aerate the water as compared to heretofore available systems (6-8 ppm as contrasted with 3-4 ppm dissolved oxygen). In accordance with the current embodiment, users (or automated delivery systems) supply food to the fish in the tank at rates sufficient to promote fish growth while avoiding fouling of downstream components (as well as the fish rearing tank) with uneaten food, excess waste products, etc.

As the fish digest the food and respirate the oxygen, they of course grow thereby producing a supply of foodstuff (their flesh) for humans, livestock, pets, etc. They also, of course, produce waste products. For instance, they defecate fecal matter which tends to be high in nitrite, low in iron (FE+2), and high in decomposable organic matter (with an attendant oxygen demand). They also excrete ammonia through their gills thereby introducing these potentially undesirable materials into the water in the system 100. In addition, the decomposition of the organic materials in the fecal matter produces methane and (to some extent) hydrogen sulfide which can also be considered to be undesirable to have present in the water in system 100. While systems 100 of the current embodiment are balanced in that they effectively manage these materials, heretofore available systems (such as system 150) often fail (at least partially) in these regards.

With continuing reference to FIG. 1A, system 100 processes the fecal matter produced by the fish in a number of ways. First, it has been observed by the Inventor that fecal matter of some fish species (for instance Tilapia) floats soon after the fish defecates and subsequently sinks. In contrast, the Inventor has observed, that the fecal matter of other fish species (for instance, catfish) sinks initially and then goes into suspension/solution with the water and/or settles out. In heretofore available systems 150, the water therefore becomes relatively turbid with higher TDS, higher oxygen demand, and lower available oxygen than systems 200 of the current embodiment. Indeed, many heretofore available systems 150 allow the fecal matter (solids 168) to collect on the bottom of their fish rearing tanks 152. This collection of fecal matter necessarily begins decomposing resulting in relatively high amounts of nitrite, methane, and hydrogen sulfide in the water in the fish rearing tank 152. Operators of such systems 150 must therefore remove the accumulated solids from the bottoms of their fish rearing tanks 152 periodically or risk the health/safety of the fish and/or vegetation therein.

In contrast to systems 150, systems 200 of the current embodiment drain the surface solids 218 to the solids/water separator 204. Moreover, they do so via the surface drains 120 and 220 as illustrated by FIGS. 1A and 2 respectively. In the current embodiment, these surface drains 120 (and 220) are pipes positioned a short distance below the expected water level in the fish rearing tanks 102 and 202. For instance, it has been found that in fish rearing tanks 102 of about 3-4 foot (non-limiting) depth, placing a 3″ surface drain 120 about 3-4 inches (also non-limiting) below the water surface results in adequate collection of surface solids 118 including solids both floating on and near the surface. The size of the surface drain 120 and its location can be determined in accordance with local conditions without undue experimentation.

Moreover, the location of the surface drain 120 can be chosen so as to enhance its ability to draw the surface solids 118 into itself. For instance, the surface drain 120 can be position on the downwind side of the fish rearing tank 102. Thus, in the presence of a reliable prevailing wind, that wind will urge the surface solids 118 toward the surface drain 120. If a reliable prevailing wind is not present (or the system 100 is located indoors) then an air blower/fan can be positioned appropriately to aid in this respect.

Moreover, while the air stones 116 can be positioned near the bottom of the fish rearing tank 102 to drive solids present at lower levels of the tank toward the surface, they can also be positioned to leave the volume of water adjacent to the surface drain relatively free of air bubbles thereby allowing these solids to accumulate if not agglomerate in the vicinity of the surface drain 120. Likewise the water nozzles 149 can be spaced apart from the surface drain 120 and/or positioned to urge surface solids 118 toward the surface drain 120. Thus, the surface drain 120 (and/or other features) of the current embodiment can be configured to collect surfaced solids from the fish rearing tank.

With continuing reference to FIGS. 1A and 2, a mixture of solids and water will therefore flow from the fish rearing tank 102 to the solids/water separator 104 via the surface drain 120. As this mixture exits the surface drain 120 via its downturned discharge 124, its momentum will urge the solids therein toward the bottom of the solids/water separator. Thus, much of the solid material will settle relatively quickly with the remainder (or a large portion thereof) settling in the solids/water separator 104 over time. Note that any gases generated by the settled solids can be stripped out via the thin film stripper 104 as is disclosed further herein.

Therefore, the settled solids 136 can be removed from the solids/water separator 104 at a convenient time rather than before they begin decomposing and/or generating potentially undesirable gases and/or other byproducts). Indeed, the solids/water separator can define a conical bottom which couples to the solids valve 134 for such purposes and/or perhaps others. When it is desired to remove solids from the system 100, a user can operate the solids valve 134 and collect the settled solids at the discharge 136. These “solids” can be dewatered and/or sold/used as high-purity, nitrogen-rich fertilizer.

With ongoing reference to FIGS. 1A and 2, some solids might remain entrained in the flowing water and exit the solids/water separator 104 via the thin film stripper 126. However, the water with the potentially entrained solids next passes through the filter bank 106. In the current embodiment, the filter bank 106 further comprises two pairs of filter elements: a first pair of “green” filter media mats 138 and a second pair of “black” filter media mats 140. Thus, the single, unitary filter bank 106 will likely remove a majority of any remaining solids entrained in the flowing water. These filter elements can be cleaned (and/or back flushed) at appropriate times to minimize the risk that they might become a source of decomposition products. Thus, by the time that the water reaches the grow tanks 108, it is largely solids-free and gas-free (other than dissolved oxygen) and therefore suitable for use in deep water/raft aquaponics environments as well as in many other applications.

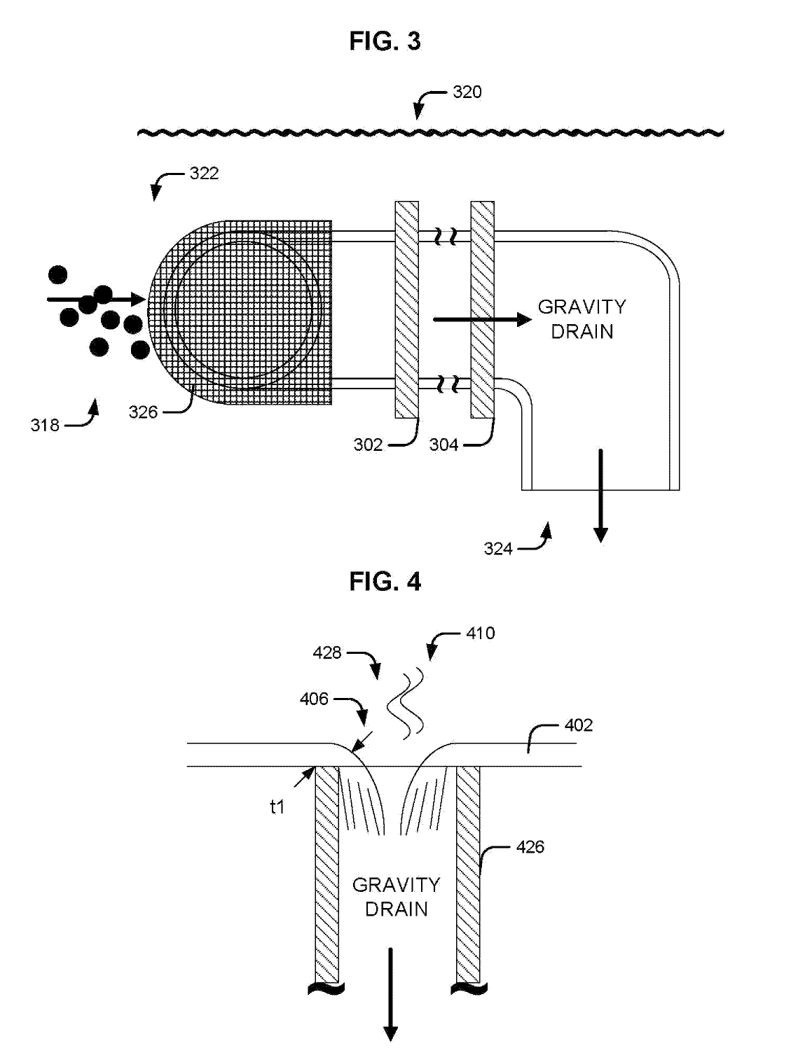

FIG. 3 illustrates a surface drain of a fish rearing tank of an aquaponics system. The surface drain 320 of the current embodiment is a passive component in that it relies on gravity to draw water and the solids located near the surface of the water in the fish rearing tank into its entrance and thence to the solids/water separator 104. Thus, it is often positioned a few inches below the surface of the water in the fish rearing tank 102 (for tanks with depths in a non-limiting 3-5 foot range) and on the downwind side of that tank. Thus, both the water currents in the system and the wind (whether natural or created with a fan) will urge the surface solids 318 toward the surface drain 320.

In the current embodiment, the surface drain 320 of the current embodiment comprises a 3 inch PVC pipe with an entrance 322 positioned in the fish rearing tank 102 and a discharge 324 positioned in the solids/water separator 104. The surface drain 320 is horizontal in the fish rearing tank 302 and turns down through about 90 degrees in the solids/water separator 104.

If desired, a portion of screen or netting 326 can be placed over the entrance 322 of this drain. The netting 326 of the current embodiment serves to prevent large debris (for instance, foreign objects, medium/large fish, etc.) that might find its way to the entrance 322 from entering the solids/water separator 104. FIG. 3 also shows, for convenience sake, the walls 302 and 304 of the fish rearing tank 102 and the solids/water separator 104 respectively. Note that if it is desired to allow fingerlings to enter the solids/water separator 104, the netting 326 can be sized to accommodate these small fish. Thus, if the user desires to control algae (and/or other growths) between the surface drain 320 and the filter bank 106, these fingerlings can freely traverse the surface drain 320.

Again with reference to FIGS. 1A and 2, certain gases in varying amounts might be present in the water as it flows from the fish rearing tank 102 to the solids/water separator 104. For instance, the ammonia secreted by the fish will be present in many scenarios. Varying amounts of methane and hydrogen sulfide might be present as well or in the alternative. The thin film stripper 126 of the current embodiment can eliminate, if not reduce, the concentrations of these gases in the water reaching the grow tanks 108 and being recycled back to the fish rearing tanks 102. At this juncture, it might now be helpful to refer to FIG. 4.

FIG. 4 illustrates a thin film stripper of a solids/water separator of an aquaponics system. As disclosed elsewhere herein, certain gases might be present in the water in the fish rearing tank 102 (and/or elsewhere). These gases include the ammonia excreted via the gills of the fish, methane, hydrogen sulfide, etc. The thin film striper 426 of the current embodiment serves to strip or eliminate these gases from the water (ammonia, as disclosed elsewhere herein is also or in the alternative eliminated via the nitrogen cycle of the system 100). The thin film stripper 126 also provides another opportunity to aerate the water.

More specifically, the thin film stripper 426 of the current embodiment draws a thin film 406 of water from the surface 402 in the solids/water separator 104. That thin film 406 flows over the lip/edge of the thin film separator 406 and free falls in a cascade 408 down through the thin film stripper 426. As the water falls, surface tension serves to draw it into droplets and/or thin sheets of water which increases the surface area of the water. This allows gases 410 to escape from the water and vent, typically, from the entrance 428 of the thin film stripper 426. Note also, that as the cascade 408 of water encounters water pooling in the bottom of the thin film stripper 426, splashing often occurs allowing yet more gas 410 to escape from the water. Note that these actions also provide an opportunity for atmospheric oxygen to dissolve in the water as it cascades/splashes in the thin film stripper 426.

In the current embodiment, the thin film stripper 426 comprises another 3 inch PVC pipe. Note that the speed/volumetric rate of the pump can be set to create the thin film 406 of water as well as determine its thickness t1 (in conjunction with the size of the thin film stripper 426). It might also be helpful to disclose at this juncture that the height of the entrance 428 of the thin film stripper 426 will set the height of the surfaces in the solids/water separator 104 and fish rearing tank 102 but for head differences created by the water flowing through pertinent portions of the system 100. Note also that in the current embodiment, the thin film stripper 426 resides in the solids/water separator and can even be deemed a (sub) component thereof. However, the thin film stripper 426 could be a separate component of the system 100 if desired.

Some disclosure regarding the filter bank 106 might be helpful at this juncture. In the current embodiment, the filter bank 106 is a separate, unitary component comprising all of the filters of the system 100 although this need not be the case to practice the current disclosure. More specifically, the filter bank 106 of the current embodiment comprises two pairs of filters: one pair comprising green filter media mats, the other pair comprising black filter media mats. It has been found that placing the green filters upstream of the black filters prevents most particulate matter (that is, solids which might travel though the solids/water separator 104) from reaching the grow tanks 108. If desired, these filters can be removed for cleaning and/or backwashed periodically.

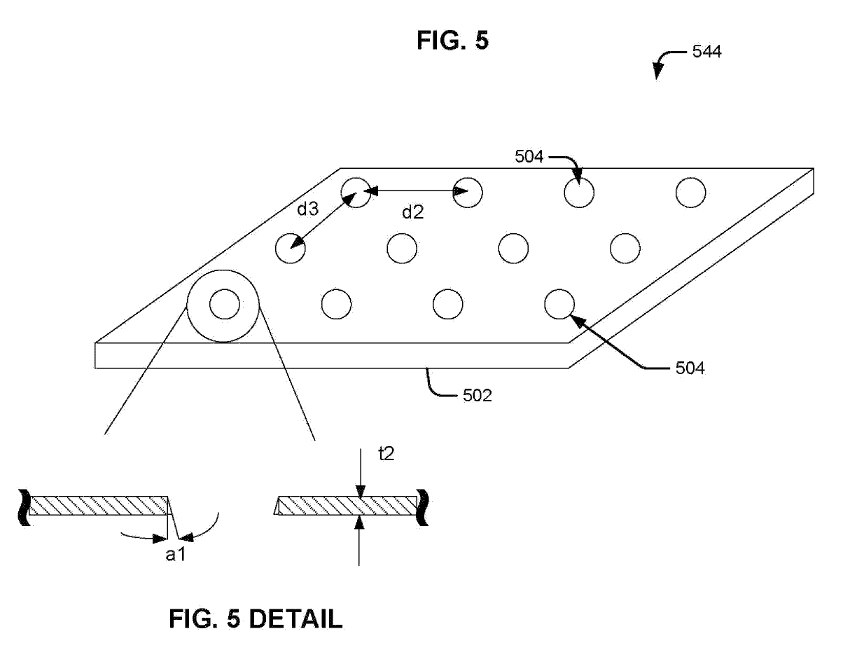

FIG. 5 illustrates a grow raft of an aquaponics system. The grow raft 544 of the current embodiment defines a 2 foot by 4 foot body 502 made from polyethylene. However, other raft sizes (for instance, 4 foot by 8 foot) are within the scope of the current disclosure. The polyethylene body 502 provides mechanical support for the grow cups (and plants) that might be in one or more of the plant apertures 506 and which are further defined by the body 502. In the current embodiment, the polyethylene body is compatible with good plant health and/or safety (and that of the fish) in that it is neither soluble in water nor likely to degrade in an aquatic environment even if exposed to sun light or other sources of ultraviolet light. Moreover, polyethylene typically does not form (or include) cells in its interior thereby minimizing locations for bacteria and/or other pathogens to colonize, grow in, propagate from, etc.

These grow rafts 544 are placed in the grow tanks 108 and allow plants to grow in the water therein. Note that in the current embodiment, the system 100 is an aquaponics system 100 and therefore no gravel, sand, vermiculite, etc. is placed in the grow tanks 108. Rather, as is disclosed elsewhere herein the plants receive their nutrients through the water in the system. Indeed, the system 100 contains, defines, benefits from, etc. a nitrogen cycle. More specifically, naturally occurring bacteria in the water in the fish rearing tank 102 convert the nitrogen therein first from ammonia then to nitrite. Other naturally occurring bacteria then convert the nitrite to nitrate which the plants in the grow rafts 144 absorb through their roots thereby removing the nitrogen from the water. This process is often deemed mineralization, solarization, and/or bedding of this nitrogen.

Of course, the plants typically need other “essential” minerals to grow to maturity. Most of these minerals can be found in typical water supplies. For instance, many river-based municipal water systems have enough of these essential minerals dissolved in the treated water (particularly after the fish defecate in it) that little in the way of supplements need to be added to the water for the plants. One possible exception is iron (Fe+2) which can be typically scarce in most bio systems. Thus, chelated iron can be added as desired to maintain healthy levels of iron in the water for both the plants and the fish.

In the current embodiment, the body 502 defines a plurality of plant apertures 506. These plant apertures are 3 inches in diameter d1 although 2 inch and other diameters are within the scope of the disclosure. Of course, the amount of coco fiber (or other matrix) supplied therein can vary with the size of the grow cup. For instance, 1 ounce of coco fiber can be used with a 2 inch cup whereas 2.2 ounces of coco fiber can be used with a 3 inch cup. The plant apertures 506 are spaced apart by distances d2 and d3 of respectively 12 inches and 8 inches across the surface of the grow raft 544. Thus, for a grow board of 2 foot by 8 foot overall dimensions, the plant apertures 506 can be arranged to form a 3 by 4 matrix or array. Note also that the plant apertures 506 can have sides sloped at about 10 degrees to facilitate the insertion and removal of the grow cups (not shown) while also providing support to the same.

It has been found that the size of the plant apertures 506 of the current embodiment allows many plants (for instance, lettuce) to reach full maturity and/or size. It has also been found that the spacing of the plant apertures 506 of the current embodiment prevents adjacent plants from growing together and/or becoming entangled with one another. These features therefore allow one plant to be removed from the system 100 without affecting other plants. Moreover, should one plant become affected by parasites, bacteria, etc., these features tend to quarantine the affected plant thereby preventing or at least slowing the spread of the issue.

With reference again to FIG. 1, the water in the system 100 flows from the pump 110, to the fish rearing tank 102, through the solids/water separator, through the filter bank 106, and thence to the grow tank(s) 108. From there, the system routes the water back to the pump 110 and then through the recirculation line 146 to the fish rearing tank 102. A portion of the recirculating water can be routed through the water manifold 148 and thence out through the water nozzles 149. These water nozzles can be placed around and over the fish rearing tank 102. Thus, as the water discharges from the water nozzles 149 an opportunity for further aeration occurs. The remaining portion of the recirculating water can flow through the recirculation line 146 and into the fish rearing tank 102. In this regard, the recirculation line 146 can terminate in an upwardly pointing section of pipe submerged in the fish rearing tank a few inches beneath the surface of the water therein.

Furthermore, the air pump 112 can drive a portion of the aeration of the water. More specifically, the air pump 112 can pump atmospheric air to the air manifold(s) 114. The air manifold 114 distributes the pumped air to the air stones 116 positioned in the fish rearing tank 102. Note that these air stones 116 can be spaced apart in the tank from one another so as to distribute the pumped air to a large portion of the water therein. The resulting air bubbles, it has been found, tend to drive solids floating in the water toward the surface and once there toward the surface drain 120. In some embodiments, though, the air stones 116 are spaced apart from the surface drain 120 by several feet so as to allow a calm, or slack, area of water near the surface drain 120 in which the solids can accumulate and/or agglomerate for collection by that drain.

Additionally, or in the alternative, air stones 116 can be placed in the grow tanks 108. These air stones can help provide dissolved oxygen to the roots of the plants. Moreover, combined with the other sources of aeration in the system 100, these air stones can help over-aerate the water above the typical 3-4 ppm range to about 6-8 ppm. It has been found that this non-limiting degree of over aeration promotes the nitrogen cycle of the system 100 and both plant and fish safety.

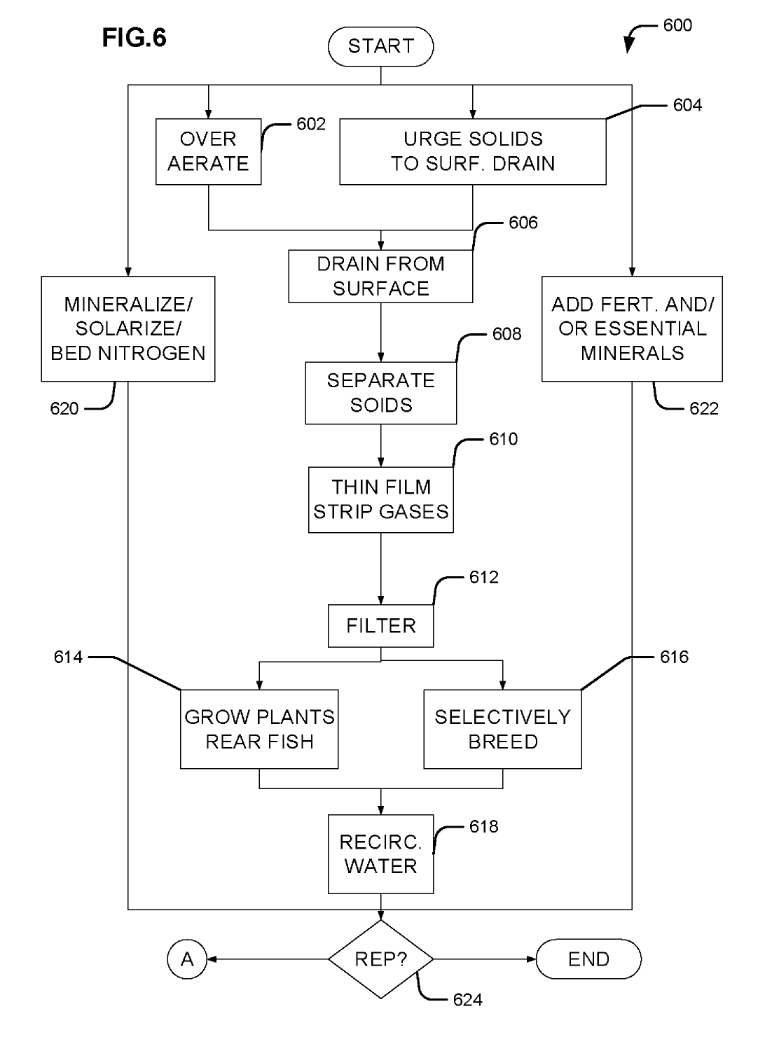

FIG. 6 illustrates a flowchart of a method of growing food in an aquaponics system. More specifically, FIG. 6 illustrates method 600 which comprises various operations such as over aerating the water in an aquaponics system 100. See reference 602. In parallel, if desired, solids in the water can be urged toward the surface and/or surface drain 120 via the air bubbles produced by the air stones 116 and/or wind, air currents in the vicinity, etc. as illustrated at reference 604.

A mixture of these solids and water can be drained from the surface of the fish rearing tank 102 as illustrated at reference 606. Of course, solids can be collected and/or drained from the bottom of the fish rearing tank 102 in addition or in the alternative.

Moreover, method 600 further comprises separating the solids from the water. See reference 608. The separation can be accomplished in the solids/water separator 104 if desired. Note that the separated solids can be drained from the solids/water separator 104, dewatered, compressed, and/or further processed before being sold, used as fertilizer, disposed of, etc. It has been found that solids drained from systems of embodiments are impurity-free (at least to the extent detectable by current methods).

In accordance with the various embodiments, the water (now largely solids free) from the solids/water separator 104 can be thin film stripped of at least a portion of the gases therein. For instance, methane, residual ammonia, hydrogen sulfide, etc. can be removed from the water in the thin film stripper 126. See reference 610. However, it has been found that passage of the water through the thin film stripper can actually increase its dissolved oxygen content.

Method 600 can also comprise filtering the water in filter bank 106 or as otherwise might be desired. See reference 612. The resulting filtered, largely solids-free water (which is now believed to be rich with at least partially mineralized nitrogen) can be supplied to the grow tanks 108. Therein, various types of plants can be grown on the grow rafts 144 of the aquaponics system 100. Meanwhile, using recirculated water from the grow tanks 108, fish can be grown in the fish rearing tank 102. Thus, reference 614 illustrates growing various types of fish (tilapia, catfish, etc.) and plants (lettuce, flowers, herbs, etc.) in system 100.

Note that selective breeding can be used in conjunction with system 100. For instance, the fish to be introduced into the fish rearing tank 102 can be selected for size and/or other desirable characteristics. In addition, or in the alternative, seeds can be germinated and selected for subsequent inclusion in the system 100 based on their seedling size and/or other characteristics. See reference 616.

Of course, the water in the system 100 can be recirculated from the grow tanks 108 to the fish rearing tank 102. Moreover, this recirculated water can be maintained (in accordance with some or all of the techniques disclosed herein) with higher quality than expected were only SRAC 454 practices to be followed. See reference 618.

In the meantime, system 100 (including the aspects thereof related to over aeration of the water) can facilitate the mineralization/solarization/bedding of the nitrogen in the system 100. More specifically, naturally occurring bacteria populations in the water can convert the ammonia excreted by the fish to nitrite and thence to nitrate. Indeed, the water produced by systems 100 can be as rich in nitrate as the nutrient solutions supplied for many hydroponics systems. The nitrate in the recirculating water, of course, can be used by the plants in the system 100 as a source of nutrition. See reference 620.

Reference 622 illustrates that essential minerals (and/or other nutrients) can be added to the water if desired. For instance, many sources of water are somewhat depleted/lacking in iron (Fe+2). Thus, chelated iron can be added to the water at a rate sufficient for both the fish and the plants therein. Other essential minerals can be added should analysis of the water indicate that it might be desirable to do so.

Of course, the plants and/or fish can be harvested periodically or on some other schedule. Then, if desired, method 600 can be repeated in whole, in part, and/or in some other order as indicated at reference 624.

Various embodiments provide indoor and/or stand-alone aquaponics systems and can be operated in accordance with clean fish practices. These systems can comprise grow tanks with 8″, 10″, 12″, etc. depths. While some embodiments comprise sand, gravel, vermiculite, etc. in the grow beds, systems of some embodiments exclude such materials form the grow beds. And, accordingly, do not displace water in the affected volume that could otherwise contribute to the volume of water considered to be desirable for safe fish rearing (for instance 580 or 10 gallons of water per fish). Grow rafts of embodiments can be made of polyethylene and can be stackable. Furthermore, systems of embodiments include no organics materials other than the fish, the plants, and their byproducts and, notably, no detectable pathogens. Such systems are therefore “safe” and “clean” for the plants and the fish.

Systems of various sizes are also provided herein since embodiments are scalable. For instance, some embodiments provide “walk around” systems which fit within footprints of 10 feet by 20 feet. Such systems can include one grow bed, one aquarium (or fish rearing tank), and one filter with a combined water volume of about 800 gallons. Embodiments also provide systems comprising additional components and which therefore have water volumes of 1000, 2000, and 18,000 gallons. Many of these systems provide for the removal/management of both solids and gases within the water.

Systems of many embodiments recirculate the water with or without grow beds and/or plants therein. Many of these system eliminate, if not, reduce the amount of intervention required by human operators. In contrast to heretofore available systems, systems of embodiments collect solids from the surface and/or near surface of the water rather than collecting solids from the bottom of the fish tank. Moreover, plants grown in systems of embodiments can grow unexpectedly larger than predicted by those skilled in the art. For instance, many seed packets predict that plants (lettuce for instance) grown from seeds therein will weigh 7-10 ounces. Yet those seeds, if germinated, allowed to grow for a few days without external nutrients, and then feed with nutrient water from grow tanks of embodiments will grow to 12-14 ounces in weight.

Thus, the current disclosure provides aquaponics systems, machines, components, apparatus, methods, etc. These systems (et al.) are resilient and unless somehow upset by outside factors produce recirculated water and food (both plants and fish) of superior and unexpected quality and quantity. Indeed, some in the art have begun referring to systems such as those of embodiments as agricultural “machines.” Note that various aquaponics components, apparatus, systems, machines, etc. in accordance with embodiments are available from Apex Aquaponics, LLC, of San Marcos, Tex.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. An agricultural machine for rearing fish comprising:
a solids/water separator configured to separate solids and water from each other;
a fish rearing tank configured to contain fish in water; and
a surface drain in fluid communication with the solids/water separator and being positioned in the fish rearing tank so as to drain a solids/water mixture from a surface of the water in the fish rearing tank and to drain the solids/water mixture to the solids/water separator whereby the solids/water separator to separate fish fecal matter from the water.

2. The agricultural machine of claim 1 wherein the fish rearing tank and the solids/water separator are further configured to gravity drain the solids/water mixture to the solids/water separator.

3. The agricultural machine of claim 1 further comprising a thin film stripper positioned in the solids/water separator.

4. The agricultural machine of claim 3 further comprising a pump in communication with the fish rearing rank and being positioned upstream of the fish rearing tank.

5. The agricultural machine of claim 4 wherein the pump is further configured to pump water at a rate sufficient to create a vortex at an entrance to the thin film stripper.

6. The agricultural machine of claim 1 wherein the surface drain is positioned near a side of the fish rearing tank downwind from a prevailing wind in a vicinity of the fish rearing tank.

7. The agricultural machine of claim 1 further comprising a plurality of air stones spaced apart from the surface drain.

8. The agricultural machine of claim 1 further comprising an air pump in fluid communication with the air stones and being configured to pump air at a rate sufficient to over-aerate the water in the fish rearing tank.

9. The agricultural machine of claim 1 further comprising a plant growing tank in fluid communication with the solids/water separator.

10. The agricultural machine of claim 9 further comprising a polyethylene grow raft positioned in the plant growing tank.

11. An agricultural method for rearing fish comprising:
draining a solids/water mixture from a surface of water in a fish rearing tank to a solids/water separator configured to separate solids and water in the solids/water mixture via a surface drain positioned in the fish rearing tank so as to drain the solids/water mixture from the fish rearing tank to the solids/water separator; and
separating at least some of the solids from the water of the solids/water mixture using the solids/water separator whereby fish fecal matter is separated from the water.

12. The agricultural method of claim 1 wherein the fish rearing tank and the solids/water separator are further configured to gravity drain the solids/water mixture to the solids/water separator.

13. The agricultural method of claim 1 further comprising passing the water separated from the solids through a thin film stripper positioned in the solids/water separator.

14. The agricultural method of claim 3 further comprising pumping the water into the fish rearing rank with a pump positioned upstream of the fish rearing tank.

15. The agricultural method of claim 4 wherein the pump is configured to pump the water at a rate sufficient to create a vortex at an entrance to the thin film stripper.

16. The agricultural method of claim 1 wherein the surface drain is positioned near a side of the fish rearing tank downwind from a prevailing wind in a vicinity of the fish rearing tank.

17. The agricultural method of claim 1 further comprising spacing apart a plurality of air stones from the surface drain.

18. The agricultural method of claim 1 further comprising pumping air at a rate sufficient to over-aerate the water in the fish rearing tank with an air pump in fluid communication with the air stones.

19. The agricultural method of claim 1 further comprising growing plants in a plant growing tank in fluid communication with the solids/water separator.

20. An agricultural machine for rearing fish comprising:
a solids/water separator configured to separate solids and water from each other;
a fish rearing tank configured to contain fish in water;
a surface drain in fluid communication with the solids/water separator and being positioned in the fish rearing tank so as to drain a solids/water mixture from a surface of the water in the fish rearing tank and to drain the solids/water mixture to the solids/water separator, the surface drain being further positioned near a side of the fish rearing tank downwind from a prevailing wind in a vicinity of the fish rearing tank whereby the solids/water separator to separate fish fecal matter from the water;
a pump in fluid communication with the fish rearing tank and positioned upstream of the fish rearing tank;
a thin film stripper positioned in the solids/water separator the pump being configured to pump water at a rate sufficient to create a vortex at an entrance to the thin film stripper;
a plurality of air stones spaced apart from the surface drain; and
an air pump in fluid communication with the air stones and being configured to pump air at a rate sufficient to over-aerate the water in the fish rearing tank.
